(19) United States
(12) Patent Application Publication
(10) Pub. No.: US 2013/0293518 A1
(43) Pub. Date: Nov. 7, 2013

(54) PICTURE DISPLAY APPARATUS, PICTURE DISPLAY SYSTEM, AND SCREEN

(71) Applicant: Masaki Otsuki, Yokohama-shi (JP)

(72) Inventor: Masaki Otsuki, Yokohama-shi (JP)

(21) Appl. No.: 13/979,621

(22) PCT Filed: Jan. 11, 2012
(86) PCT No.: PCT/JP2012/050302

§ 371 Date: Jul. 12, 2013

(30) Foreign Application Priority Data
Jan. 13, 2011 (JP) 2011-004497

(51) Int. Cl. G06F 3/042

(52) U.S. Cl. CPC G06F 3/0425
USPC 345/175

(57) ABSTRACT

A picture display apparatus includes a screen including a light guide plate which propagates a light of a specific wavelength inside and has a diffuser structure 24 for diffusing a visible light on one surface, a projection unit for projecting an image on the screen by the visible light, a photographing unit for photographing the light of a specific wavelength, and a position specification unit which, when the light of a specific wavelength propagated inside the light guide plate is reflected by an object contacting the light guide plate, specifies a position at which the object contacts the light guide plate after the photographing unit photographs the reflected light.

### TECHNICAL FIELD

The present invention relates to a picture display apparatus, a picture display system, and a screen.

### BACKGROUND ART

A picture display apparatus which recognizes a contact position when a finger or a pen contacts a display surface for displaying an image is known (for example, see Patent Literature 1). This picture display apparatus has an emitting unit for emitting a light flux film on an entire display screen and a light receiving unit for receiving the light and recognizes a light intensity distribution on the entire display screen. When a finger, a pen or the like contacts the display screen and a portion of the light flux film is blocked, the picture display apparatus specifies a location where the light intensity is lowered as a contact position where the finger, the pen or the like contacts the display screen.

### CITATION LIST

### Patent Literature

Patent Literature 1: JP 2003-208240 A

### SUMMARY OF INVENTION

### Technical Problem

However, when dust or the like is attached to the emitting unit or the light receiving unit, the picture display apparatus of the above-described Patent Literature 1 sometimes cannot correctly recognize the light intensity distribution and cannot specify the contact position by the finger, the pen or the like.

An object of the present invention is to provide a picture display apparatus and a picture display system which can reliably specify a contact position of an object onto a display surface and to provide a screen used by the picture display apparatus and the picture display system.

### Solution to Problem

A picture display apparatus of the present invention is characterized by including: a screen including a light guide plate which propagates a light of a specific wavelength inside and has a diffuser structure for diffusing a visible light on one surface; a projection unit for projecting an image on the screen by the visible light; a photographing unit for photographing the light of a specific wavelength; and a position specification unit which, when the light of a specific wavelength propagated inside the light guide plate is reflected by an object contacting the light guide plate, specifies a position at which the object contacts the light guide plate after the photographing unit photographs the reflected light.

A picture display system of the present invention is characterized by including: a screen having a light guide plate which propagates a light of a specific wavelength inside and includes a diffuser structure for diffusing a visible light on one surface; and a camera with a projector which has a projection unit for projecting an image on the screen by the visible light, a photographing unit for photographing the light of a specific wavelength, and a position specification unit which, when the light of a specific wavelength propagated inside the light guide plate is reflected by an object contacting the light guide plate, specifies a position at which the object contacts the light guide plate of the screen after the photographing unit photographs the reflected light.

A screen of the present invention is characterized by including: a light guide plate which propagates a light of a specific wavelength inside; and diffuser structure which is provided on one surface of the light guide plate and diffuses a projection light projecting an image, wherein when the light of a specific wavelength is reflected by an object contacting another surface of the light guide plate, the reflected light is emitted from the one surface of the light guide plate.

### Advantageous Effects of Invention

According to the present invention, the contact position of the object onto the display surface can be reliably specified.

### BRIEF DESCRIPTION OF DRAWINGS

FIG. 1 is a diagram showing a structure of a picture display apparatus relating to a first embodiment.

FIG. 2 is a diagram showing a structure of a screen relating to the first embodiment.

FIG. 3 is a diagram showing a state where a person's finger contacts a light guide plate.

FIG. 4 is a diagram showing an image of the screen photographed by an infrared camera unit when an object contacts the light guide plate.

FIG. 5 is a diagram showing a boundary unit between the light guide plate and a diffuser panel.

FIG. 6 is a diagram showing a structure of a picture display apparatus relating to a second embodiment.

FIG. 7 is a diagram showing a structure of a picture display apparatus relating to a third embodiment.

FIG. 8 is a diagram showing a structure of a picture display apparatus relating to a fourth embodiment.

FIG. 9 is a diagram showing another structure of the picture display apparatus relating to the fourth embodiment.

FIG. 10 is a diagram showing a structure of a picture display system relating to a fifth embodiment.

FIG. 11 is a diagram showing a positioning member of a screen used in the picture display system relating to the fifth embodiment.

### DESCRIPTION OF EMBODIMENTS

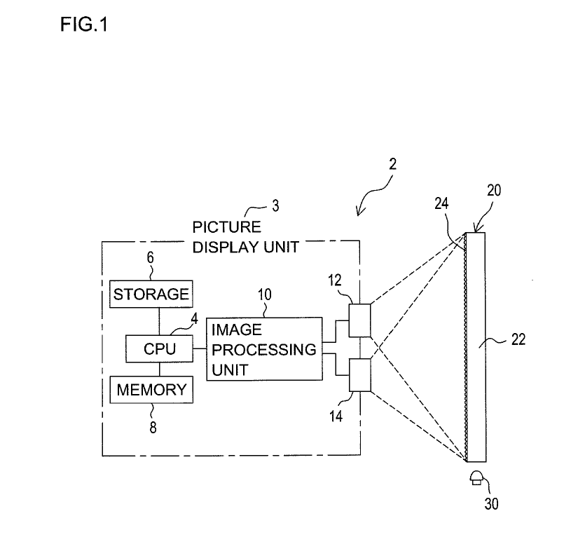

Referring to the drawings, a picture display apparatus relating to a first embodiment will be described below. FIG. 1 is a diagram showing a structure of the picture display apparatus relating to the first embodiment. A picture display apparatus 2 of the present embodiment effects projection of a picture from a rear side of a screen 20 and displays the picture on the screen 20.

The picture display apparatus 2 is formed by a picture display unit 3 and the screen 20. The picture display unit 3 includes a CPU 4. A storage 6, a memory 8, and an image processing unit 10 are connected to the CPU 4, and further, a projector unit 12 and an infrared camera unit 14 are connected thereto via the image processing unit 10. The CPU 4 controls the respective units according to a control program stored in the storage 6 and carries out a projection process by a projector function, a photographing process by a camera function, a position specifying process of specifying a contact position when an object contacts the screen 20 described below, and the like. The memory 8 stores picture data of pictures projected by the projector unit 12, image data photographed with the infrared camera unit 14, and the like.

Based on photographed data output from the infrared camera unit 14, the image processing unit 10 generates image data to be stored in the memory 8. Moreover, the image processing unit 10 generates picture data of pictures to be projected by the projector unit 12 from the image data stored in the memory 8. By projecting a projection light, which is a visible light, toward the rear surface of the screen 20, the projector unit 12 projects a picture on the screen 20 based on the picture data. The infrared camera unit 14 photographs an infrared light emitted from the rear surface of the screen 20 from a position at which the entire rear surface of the screen 20 is photographable.

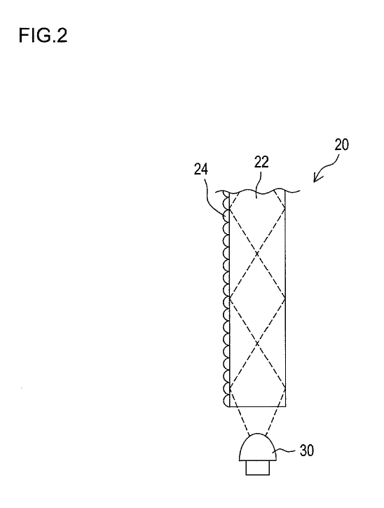

As illustrated in FIG. 2, the screen 20 is composed of a light guide plate 22 which is formed of a plate-shaped glass material and propagates an infrared light inside and a diffuser panel 24 which is formed of a glass material having a large dispersion of a visible light. The screen 20 is structured by superimposing the diffuser panel 24 on one surface of the light guide plate 22. A material having Abbe number, which is the reciprocal of dispersion, of 40 or more is used as the glass material having a large dispersion of a visible light. It should be noted that the dispersion is defined by the formula: (n_{F}−n_{C})/(n_{D}−1), where n_{F} is a refractive index relative to Fraunhofer F line (486.1 nm), n_{C} is a refractive index relative to Fraunhofer C line (656.3 nm), and n_{D} is a refractive index relative to Fraunhofer D line (589.3 nm), for example.

Further, the light guide plate 22 is formed of the material having an absolute refractive index higher than an absolute refractive index of the material forming the diffuser panel 24 by approximately 0.05 in such a manner that the infrared light propagated inside is totally reflected by a contact surface between the light guide plate 22 and the diffuser panel 24.

An infrared light source 30 which irradiates and propagates the infrared light inside the light guide plate 22 is disposed at least one end of the screen 20. It should be noted that an unillustrated cover for preventing dust or the like from attaching to the infrared light source 30 is provided between an end portion of the light guide plate 22 and the infrared light source 30. The screen 20 is disposed in such a way that the diffuser panel 24 side thereof opposes the projector unit 12. By projecting a picture from the projector unit 12 on the diffuser panel 24, which is a rear side of the screen 20, the picture is displayed on the screen 20.

Next, description will be given of a process of detecting a contact position of an object which contacts the screen 20 in the picture display apparatus 2. The infrared camera unit 14 photographs the rear side of the screen 20, i.e., the diffuser panel 24 side, and based on the image data, the CPU 4 monitors existence of an object which contacts a front side of the screen 20, i.e., the light guide plate 22. More specifically, the CPU 4 determines the existence of the object which contacts the light guide plate 22 by monitoring existence of the infrared light emitted from the diffuser panel 24.

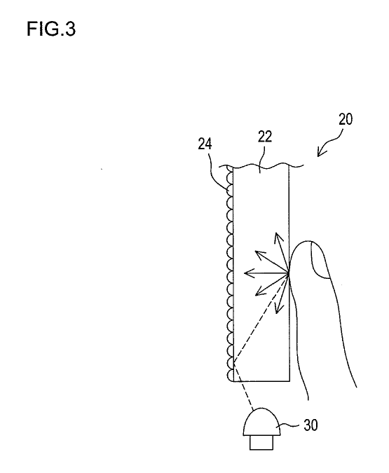

FIG. 3 is a diagram showing a state where a person's finger contacts the light guide plate 22. When a person's finger contacts the front side of the screen 20, i.e., a surface of the light guide plate 22, as illustrated in FIG. 3, the infrared light propagated inside the light guide plate 22 is diffusely reflected at a location where the finger contacts the light guide plate 22. A portion of the infrared light diffusely reflected in this way is emitted from the diffuser panel 24 side of the light guide plate 22.

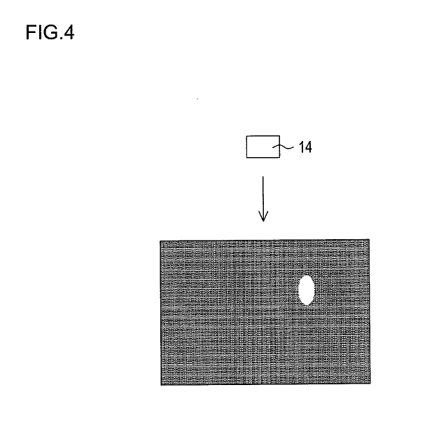

FIG. 4 is a diagram showing an image of the screen 20 photographed by the infrared camera unit 14 when the object contacts the light guide plate 22. As illustrated in FIG. 4, only a region where the infrared light is emitted, i.e., a location corresponding to a region where the object contacts the light guide plate 22 and the infrared light is diffusely reflected, is photographed as a bright image. Accordingly, based on the image data photographed with the infrared camera unit 14, the CPU 4 specifies a surface position on the screen 20 corresponding to the region photographed as the bright image as a contact position of the object. By so doing, the contact position of the object on the screen 20 projecting a picture can be specified.

According to the picture display apparatus relating to the present embodiment, the infrared camera unit photographs the infrared light emitted from the light guide plate due to the contact with the object thereon and the contact position of the object contacting the screen is specified. Consequently, the contact position of the object onto the screen can be reliably specified.

Further, in the present embodiment, the diffuser panel of the screen is formed of the material having large diffusion in such a manner that a user can clearly see a picture projected by the projector unit with unchanged brightness from any direction. Since the infrared light is not diffused in the diffuser panel, the contact position of the object onto the screen based on the image photographed by the infrared camera unit can be correctly specified without generating an error to an actual position.

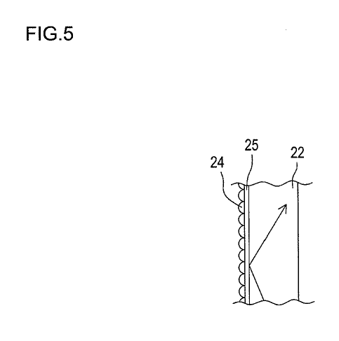

In the first embodiment, since the diffuser panel 24 is formed of the material having a lower refractive index than the light guide plate 22, the infrared light propagated inside the light guide plate 22 is reflected by a boundary between the light guide plate 22 and the diffuser panel 24. However, as illustrated in FIG. 5, for example, an air layer 25 or a glass material having a lower refractive index than the light guide plate 22 may be held between the light guide plate 22 and the diffuser panel 24. Accordingly, the infrared light propagated inside the light guide plate 22 is reflected by the boundary between the light guide plate 22 and the air layer 25 or the glass material having a lower refractive index than the light guide plate 22.

Moreover, in the aforementioned first embodiment, the light guide plate 22 and the diffuser panel 24 are formed of the glass material. However, the material is not limited to this. Even if the material is a transparent material, such as an acrylic plate, the contact position of the object onto the screen can be reliably specified likewise.

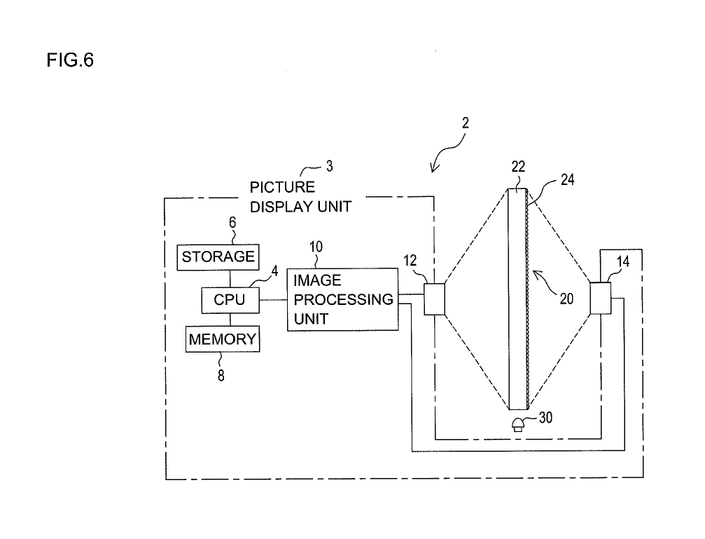

Next, a picture display apparatus relating to a second embodiment will be described. The picture display apparatus of the present embodiment is different from the above-described first embodiment in that a projection light is projected from a front of a screen 20, that a picture is projected on a front surface of the screen 20, and that the screen 20 is photographed from a rear side of the screen 20. FIG. 6 is a diagram showing a structure of the picture display apparatus relating to the second embodiment. It should be noted that structures similar to those in the picture display apparatus 2 relating to the aforementioned first embodiment are denoted by the same reference numerals.

In a picture display apparatus 2 of the present embodiment, since the picture is projected on the front surface of the screen 20, a projector unit 12 is disposed on the front side of the screen 20, i.e., at a position facing a light guide plate 22. Further, an infrared camera unit 14 is disposed on the rear side of the screen 20, i.e., at a position on a diffuser panel 24 side.

Next, description will be given of a process of detecting a contact position of an object which contacts the screen 20 in the picture display apparatus 2 relating to the present embodiment. The infrared camera unit 14 photographs the diffuser panel 24 which is the rear side of the screen 20, and based on the image data, a CPU 4 monitors the existence of an object which contacts the front side of the screen 20, i.e., a surface of the light guide plate 22. When the object contacts the light guide plate 22, an infrared light propagated inside the light guide plate 22 is diffusely reflected at a location where the object contacts and is emitted from the diffuser panel 24 side of the screen 20. Accordingly, based on the image data photographed with the infrared camera unit 14, the CPU 4 can specify the contact position of the object.

According to the picture display apparatus relating to the present embodiment, even if the picture display apparatus projects a picture on the front surface of the screen and displays the picture on the screen, the contact position of the object can be reliably specified on the screen as in the aforementioned first embodiment.

In the above-described first and second embodiments, the screen 20 is formed in the shape of a flat plate. However, the screen 20 may be formed in the shape of a concave curve or a convex curve. Here, since the screen 20 is formed by the light guide plate 22 propagating the infrared light inside and the diffuser panel 24, the screen 20 can be easily formed in the shape of a concave curve or a convex curve.

Next, a picture display apparatus relating to a third embodiment will be described. The picture display apparatus of the present embodiment is different from the aforementioned first embodiment in that a screen is formed in the shape of a concave curve, such as a spherical shape, and a projector unit and an infrared camera unit share a portion of optical members. In the picture display apparatus relating to the present embodiment, a picture displayed on a concave curved surface, which is an inner wall surface of the spherical screen, is watched from an outside of the screen.

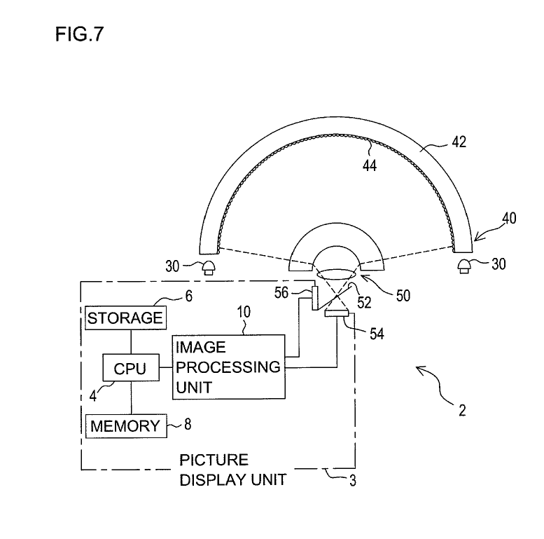

FIG. 7 is a diagram showing a structure of the picture display apparatus relating to the third embodiment. It should be noted that structures similar to those in the picture display apparatus 2 relating to the above-described first embodiment are denoted by the same reference numerals. As illustrated in FIG. 7, a screen 40 of the present embodiment is structured by a light guide plate 42 which propagates an infrared light inside and a diffuser panel 44 which diffuses a visible light. Here, the light guide plate 42 has a hemispherical shape within which a hemispherical space is formed, and the diffuser panel 44 is formed on an inner wall surface of the light guide plate 42.

The diffuser panel 44 is formed using a transparent member, such as a glass material, having Abbe number of 40 or more. Further, the light guide plate 42 is formed of a transparent material having an absolute refractive index higher than the absolute refractive index of a transparent material forming the diffuser panel 44 by approximately 0.05 in such a manner that the propagated infrared light is totally reflected by a contact surface between the light guide plate 42 and the diffuser panel 44. A plurality of infrared light source 30 which irradiates and propagates an infrared light inside the light guide plate 42 is disposed at annular ends of the screen 40 at a predetermined distance. It should be noted that an unillustrated cover for preventing dust or the like from attaching each of the infrared light sources 30 is provided between the light guide plate 42 and the infrared light source 30.

A fisheye lens unit 50, a dichroic mirror 52 which reflects an infrared light and transmits a visible light, a projection unit 54 which includes an LCD for image projection and projects a projection light, which is a visible light, and an image sensor 56 which photographs an infrared light and generates an image signal are provided on the diffuser panel 44 side of the screen 40. The fisheye lens unit 50 is formed by a meniscus lens whose convex surface faces the screen 40 side and a biconvex lens disposed on a concave surface side of the meniscus lens. The fisheye lens unit 50 magnifies a projection light emitted from the projection unit 54 and transmitted through the dichroic mirror and projects the light on a substantially entire region of the diffuser panel 44. The image sensor 56 photographs the infrared light emitted from the diffuser panel 44 and reflected by the dichroic mirror 52.

Next, description will be given of a process of detecting a position of an object which contacts an outer surface of the screen 40 in the picture display apparatus 2 relating to the present embodiment. An image processing unit 10 generates image data based on an image signal output from the image sensor 56. Based on the image data, a CPU 4 monitors the existence of an object which contacts the outer surface of the screen 40, i.e., the light guide plate 42. More specifically, the CPU 4 determines the existence of an object which contacts the light guide plate 42 by monitoring the existence of the infrared light emitted from the diffuser panel 44.

When the object contacts the surface of the light guide plate 42, the infrared light propagated inside the light guide plate 42 is diffusely reflected at a location where the object contacts and is emitted from the diffuser panel 44 side of the screen 40. The emitted infrared light enters the fisheye lens unit 50, advances toward the projection unit 54, is reflected by the dichroic mirror 52, and enters the image sensor 56.

Here, an image of image data generated based on the image signal output from the image sensor 56 becomes an image in which only a location corresponding to a region where the diffuser panel 44 emits the infrared light becomes bright. Accordingly, based on the image signal output from the image sensor 56, the CPU 4 specifies an outer surface position on the screen 40 corresponding to the region photographed as the bright image as a contact position of the object. By so doing, the contact position of the object on the screen 40 projecting a picture can be specified.

According to the picture display apparatus relating to the present embodiment, similarly to the aforementioned respective embodiments, the contact position of the object on the screen can be reliably specified. Further, since the projection unit 54 and the image sensor 56 share the fisheye lens unit 50, the manufacturing cost can be reduced.

Furthermore, in the present embodiment, since the screen 40 is formed in a curved surface shape, the fisheye lens unit 50 is used to correspond to the curved surface shape of the screen 40 and the picture is projected in a distorted way. Moreover, the dichroic mirror 52 separates a light path between the image sensor 56 and the projection unit 54. As a result, the picture on the screen is reversely distorted and correctly projected on the image sensor 56. Thus, a process, such as distortion correction, is unnecessary or can be reduced.

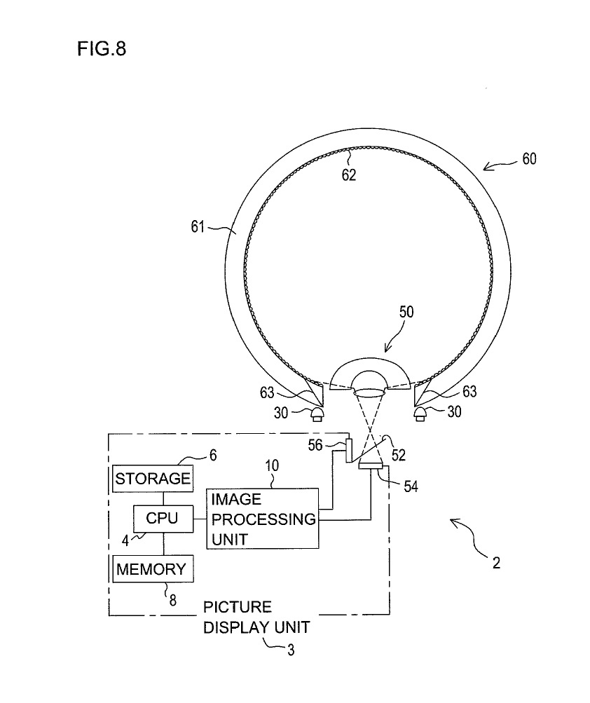

Next, a picture display apparatus relating to a fourth embodiment will be described. FIG. 8 is a diagram showing a structure of the picture display apparatus relating to the fourth embodiment. Here, in a picture display apparatus 2 relating to the fourth embodiment, the screen 40 of the picture display apparatus 2 relating to the third embodiment is changed to a screen 60. Otherwise, the picture display apparatus 2 relating to the fourth embodiment has structures similar to those in the picture display apparatus 2 relating to the third embodiment. Accordingly, structures similar to those in the picture display apparatus 2 relating to the third embodiment are denoted by the same reference numerals.

As illustrated in FIG. 8, the screen 60 of the present embodiment is structured by a light guide plate 61 which propagates an infrared light inside and a diffuser panel 62 which diffuses a visible light. Here, the light guide plate 61 has a spherical shape forming a spherical space inside and the diffuser panel 62 is formed on an inner wall surface of the light guide plate 61. A circular opening portion is formed at a lower portion of the screen 60 and a fisheye lens unit 50 is disposed at this opening portion. Further, a plurality of infrared light source 30 is provided below peripheral edges of the circular opening portion at a predetermined distance, and a mirror 63 for making an infrared light enter inside of the light guide plate 61 is disposed within the light guide plate 61 at a position corresponding to the position of the infrared light source 30.

According to the picture display apparatus relating to the fourth embodiment, when an object contacts an outer surface of the screen 60, the contact position thereof can be reliably specified.

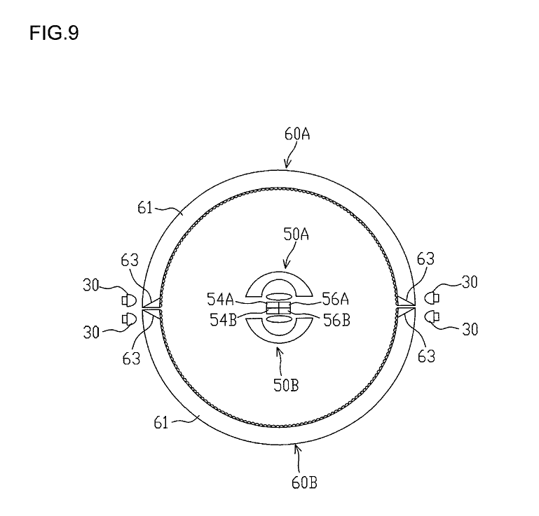

It should be noted that the picture display apparatus 2 relating to the above-described fourth embodiment includes the screen 60 which projects a picture on the inner wall surface of the sphere. However, as illustrated in FIG. 9, the screen 60 may be vertically divided into two. In this case, a fisheye lens unit 50A, a projection unit 54A, and an image sensor 56A for an upper screen 60A and a fisheye lens unit 50B, a projection unit 54B, and an image sensor 56B for a lower screen 60B are provided in a space formed by the upper screen 60A and the lower screen 60B. Further, an infrared light source 30 is provided at an annular end portion of the screen 60A at a predetermined distance in the circumferential direction, and a mirror 63 for making an infrared light enter inside of the light guide plate 61 is disposed within the light guide plate 61 at a position corresponding to the position of the infrared light source 30. Additionally, the infrared light source 30 is provided at an annular end portion of the screen 60B at a predetermined distance in the circumferential direction, and the mirror 63 for making an infrared light enter inside of the light guide plate 61 is disposed within the light guide plate 61 at a position corresponding to the position of the infrared light source 30. Then, a contact position on the upper screen 60A is detected based on image data photographed by the image sensor 56A, and a contact position on the lower screen 60B is detected based on image data photographed by the image sensor 56B.

It should be noted that when the screen is vertically divided into two, at least one of a projection angle of a picture by the projection unit 54A via the fisheye lens unit 50A and an imaging angle by the image sensor 56A and of a projection angle of a picture by the projection unit 54B via the fisheye lens unit 50B and an imaging angle by the image sensor 56B is 180 degrees or more. Thus, a contact position of an object at a connecting portion between the upper screen 60A and the lower screen 60B can be reliably specified.

Here, the number of infrared light sources in which the infrared light is incident on the upper screen 60A and the lower screen 60B and the incident position of the infrared light can be appropriately selected based on an amount of light or the like of the one infrared light source. For example, in a case where the infrared lights are respectively incident on the upper screen 60A and the lower screen 60B from the two infrared light sources 30, the infrared lights may be incident on the inside of the light guide plate 61 from respective annular end portions across the center of the upper screen 60A, and the infrared lights may be incident on the inside of the light guide plate 61 from respective annular end portions across the center of the lower screen 60B. In this case, the incident position of the infrared light on the upper screen 60A and the incident position of the infrared light on the lower screen 60B may be deviated by 90 degrees.

It should be noted that the number of spherical screens divided is not limited to two. The screen may be divided into four or eight. For example, when the spherical screen is divided into four, each of the four projecting units projects an image in a region including each apical direction of a regular tetrahedron, each of the four image sensors photographs the region including each apical direction of a regular tetrahedron, and a contact point of an object onto the screen is specified.

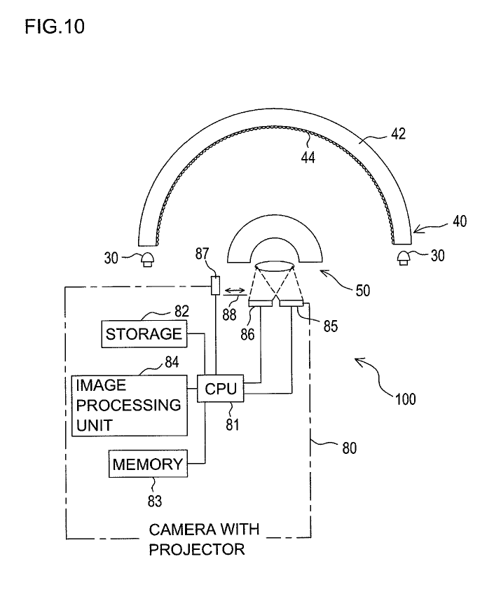

Next, a picture display system relating to a fifth embodiment will be described. FIG. 10 is a diagram showing a structure of the picture display system relating to the fifth embodiment. As illustrated in FIG. 10, a picture display system 100 relating to the fifth embodiment includes the screen 40 relating to the third embodiment and a camera with a projector 80.

Accordingly, structures similar to those in the picture display apparatus 2 relating to the third embodiment are denoted by the same reference numerals.

The camera with a projector 80 of the picture display system 100 includes a CPU 81. A storage 82, a memory 83, an image processing unit 84, a projector unit 85, a camera unit 86, and an infrared removal filter drive unit 87 are connected to the CPU 81. The CPU 81 controls the respective units according to a control program stored in the storage 82 and carries out a projection process by a projector function, a photographing process by a camera function, a position specifying process of specifying a contact position when an object contacts the screen 40, and the like. The memory 83 stores picture data of pictures projected by the projector unit 85, image data photographed by the camera unit 86, and the like.

Based on the photographed data output from the camera unit 86, the image processing unit 84 generates image data to be stored in the memory 83. Moreover, the image processing unit 84 generates picture data of pictures projected by the projector unit 85 from the image data stored in the memory 83.

When the position specifying process of specifying a contact position of an object contacting the screen 40 is performed, the infrared removal filter drive unit 87 withdraws an infrared removal filter disposed in front of the camera unit 86 from the front of the camera unit 86.

Further, when the position specifying process of specifying a contact position of an object contacting the screen 40 is performed, the camera with a projector 80 is structured in such a way that an unillustrated projection lens provided at the projector unit 85 and an unillustrated photographic lens provided at the camera unit 86 are replaceable with a fisheye lens unit 50.

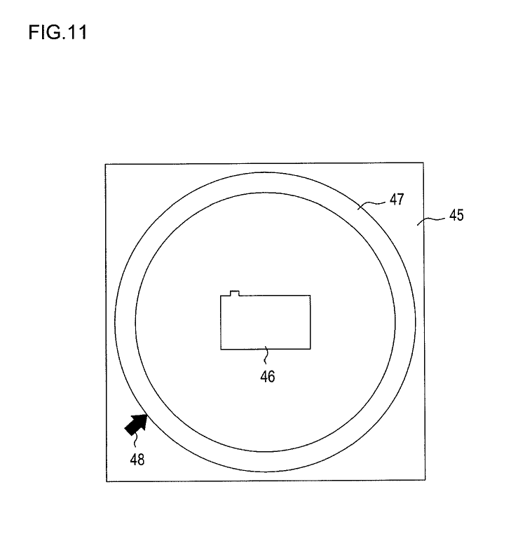

When the position specifying process of specifying a contact position of an object contacting the screen 40 is performed, the camera with a projector 80 is positioned using a positioning member 45 shown in FIG. 11. Here, it is preferable that the positioning member 45 is integrally formed with the screen 40. However, if the positioning member 45 is formed separately from the screen 40, the positional relationship with the screen 40 should be defined unambiguously.

The positioning member 45 shown in FIG. 11 includes a camera-shaped concave portion 46 in which the camera with a projector 80 is disposed at a center and an annular groove portion 47 in which the screen 40 is disposed at a circumference thereof. Moreover, an index 48 for specifying a rotational position of the screen 40 is provided at a periphery of the groove portion 47. Consequently, when the position specifying process of specifying a contact position of an object contacting the screen 40 is performed, the camera with projector 80 is disposed within the concave portion 46 and the screen 40 is disposed within the groove portion 47 at a predetermined position corresponding to the index 48.

Here, when the position specifying process of specifying a contact position of an object contacting the screen 40 is performed, since the projection unit 85 projects a picture, image data of images photographed by the camera unit 86 includes image data based on a visible light and image data based on an infrared light. Accordingly, by controlling the image processing unit 84 and removing the image data projected by the projection unit 85 from the image data of the images photographed by the camera unit 86, the CPU 81 can obtain only the image data based on the infrared light. Therefore, according to this image data based on the infrared light, the CPU 81 can specify the contact position of the object onto the screen 40.

According to the picture display system relating to the present embodiment, the contact position of the object onto the screen 40 can be specified using the camera with a projector 80 and the screen 40.

It should be noted that in the above-described fifth embodiment, the projection lens provided at the projector unit 85 and the photographic lens provided at the camera unit 86 are replaceable with the fisheye lens unit 50. However, the fisheye lens unit 50 may be disposed at a predetermined position of the screen 40.

Further, in the above-described fifth embodiment, when the position specifying process of specifying a contact position of an object contacting the screen 40 is performed, the infrared removal filter disposed in front of the camera unit 86 is withdrawn from the front of the camera unit 86. However, in addition to the imaging element for photographing a visible light, an imaging element for photographing an infrared light may be separately provided. Moreover, an infrared removal filter 88 disposed in front of the camera unit 86 may be withdrawn from the front of the camera unit 86, and an infrared transmitting filter may be instead disposed in front of the camera unit. In these cases, it is not necessary to perform the process of removing image data based on a visible light from the image data photographed by the camera unit 86.

Furthermore, in the above-described fifth embodiment, the camera with a projector 80 and the screen 40 are positioned using the positioning member 45. However, the camera with a projector 80 and the screen 40 may be positioned in such a manner that the projection unit projects a plurality of mark for contacting by a user with a finger or the like onto the screen 40 and the contact position of the user onto the screen 40 is detected based on the image data photographed by the camera unit. It is preferable that the camera with a projector 80 and the screen 40 are positioned at a predetermined time interval during a period in which the user uses the picture display system.

### REFERENCE SIGNS LIST

2 . . . picture display apparatus, 3 . . . picture display unit, 4 . . . CPU, 12 . . . projector unit, 14 . . . infrared camera unit, 20 . . . screen, 22 . . . light guide plate, 24 . . . diffuser panel, 30 . . . infrared light source, 40 . . . screen, 45 . . . positioning member, 80 . . . camera with projector, 100 . . . picture display system

1. A picture display apparatus, including:
a screen including a light guide plate which propagates a light of a specific wavelength inside and has a diffuser structure for diffusing a visible light on one surface;
a projection unit for projecting an image on the screen by the visible light;
a photographing unit for photographing the light of a specific wavelength; and
a position specification unit which, when the light of a specific wavelength propagated inside the light guide plate is reflected by an object contacting the light guide plate, specifies a position at which the object contacts the light guide plate after the photographing unit photographs the reflected light.

2. The picture display apparatus according to claim 1, wherein the diffuser structure is formed of a material with a low refractive index relative to the light guide plate.

3. The picture display apparatus according to claim 1 or 2, wherein the screen has a layer with a refractive index lower than the refractive index of the light guide plate between the light guide plate and the diffuser structure.

4. The picture display apparatus according to any one of claims 1 to 3, wherein the diffuser structure is formed of a material with a large dispersion.

5. The picture display apparatus according to any one of claims 1 to 4, wherein the light guide plate has a concave curve shape.

6. The picture display apparatus according to any one of claims 1 to 5, wherein the light guide plate has a spherical shape forming a spherical space inside and the diffuser panel is formed on an inner wall surface of the light guide plate.

7. The picture display apparatus according to any one of claims 1 to 6, wherein the projection unit and the photographing unit share at least a portion of an optical system.

8. The picture display apparatus according to any one of claims 1 to 7, wherein the light of a specific wavelength is an infrared light.

9. A picture display system, including:
a screen having a light guide plate which propagates a light of a specific wavelength inside and includes a diffuser structure for diffusing a visible light on one surface; and
a camera with a projector which has a projection unit for projecting an image on the screen by the visible light, a photographing unit for photographing the light of a specific wavelength, and a position specification unit which, when the light of a specific wavelength propagated inside the light guide plate is reflected by an object contacting the light guide plate, specifies a position at which the object contacts the light guide plate of the screen after the photographing unit photographs the reflected light.

10. The picture display system according to claim 9, wherein the camera with a projector includes a positioning means for positioning the screen.

11. The picture display system according to claim 9 or 10, wherein the diffuser structure is formed of a material with a low refractive index relative to the light guide plate.

12. The picture display system according to any one of claims 9 to 11, wherein the screen has a layer with a refractive index lower than the refractive index of the light guide plate between the light guide plate and the diffuser structure.

13. The picture display system according to any one of claims 9 to 12, wherein the diffuser structure is formed of a material with a large dispersion.

14. The picture display system according to any one of claims 9 to 13, wherein the light guide plate has a concave curve shape.

15. The picture display system according to any one of claims 9 to 14, wherein the light guide plate has a spherical shape forming a spherical space inside and the diffuser panel is formed on an inner wall surface of the light guide plate.

16. The picture display system according to any one of claims 9 to 15, wherein the projection unit and the photographing unit share at least a portion of an optical system.

17. The picture display system according to any one of claims 9 to 16, wherein the light of a specific wavelength is an infrared light.

18. A screen, including:
a light guide plate which propagates a light of a specific wavelength inside; and
a diffuser structure which is provided on one surface of the light guide plate and diffuses a projection light projecting an image,
wherein when the light of a specific wavelength is reflected by an object contacting another surface of the light guide plate, the reflected light is emitted from the one surface of the light guide plate.

19. The screen according to claim 18, wherein the diffuser structure is formed of a material with a low refractive index relative to the light guide plate.

20. The screen according to claim 18 or 19, wherein the screen has a layer with a refractive index lower than the refractive index of the light guide plate between the light guide plate and the diffuser structure.

21. The screen according to any one of claims 18 to 20, wherein the diffuser structure is formed of a material with a large dispersion.

22. The screen according to any one of claims 18 to 21, wherein the light guide plate has a concave curve shape.

23. The screen according to any one of claims 18 to 22, wherein the light guide plate has a spherical shape forming a spherical space inside and the diffuser panel is formed on an inner wall surface of the light guide plate.

24. The screen according to any one of claims 18 to 23, wherein the projection unit and the photographing unit share at least a portion of an optical system.

25. The screen according to any one of claims 18 to 24, wherein the light of a specific wavelength is an infrared light.

26. The screen, further comprising: a positioning unit for positioning a projection unit for projecting an image on the one surface of the light guide plate and a photographing unit for photographing the one surface of the light guide plate.
